(19) United States
(12) Patent Application Publication
(10) Pub. No.: US 2020/0313438 A1
(43) Pub. Date: Oct. 1, 2020

(54) ARRANGEMENT FOR CONNECTING ELECTRICAL SUPPLY SYSTEMS

(71) Applicant: SIEMENS AKTIENGESELLSCHAFT, MUENCHEN (DE)

(72) Inventors: CHRISTIAN PFEIFER, ERLANGEN (DE); ALEXANDER RENTSCHLER, BENSHEIM (DE); WALTER FILIPP ROSINSKI, WEISENDORF (DE); MARKUS DISTLER, EFFELTRICH (DE)

(21) Appl. No.: 16/649,630

(22) PCT Filed: Nov. 16, 2017
(86) PCT No.: PCT/EP2017/079376

§ 371 Date: Mar. 21, 2020

(30) Foreign Application Priority Data
Sep. 29, 2017 (DE) 10 2017 217 505.2

(51) Int. Cl. H02J 3/36; H02J 3/28

(52) U.S. Cl. CPC H02J 3/36; H02J 3/28

(57) ABSTRACT

An arrangement for connecting first and second electrical supply systems includes a medium-voltage DC line, a first converter connected on the AC-voltage side to the first supply system and on the DC-voltage side to the DC line, a second converter connected on the AC-voltage side to the second supply system and on the DC-voltage side to the DC line, and a control device controlling electrical power transmission in the DC line by using at least one converter for transmitting a temporary excess of energy in the first supply system to the second supply system. A method for operating an electrical supply system includes making a temporary excess of energy in the supply system available to a further supply system connected to a medium-voltage DC line by using the line to which the supply system is connected by a converter, for stabilizing the supply system.

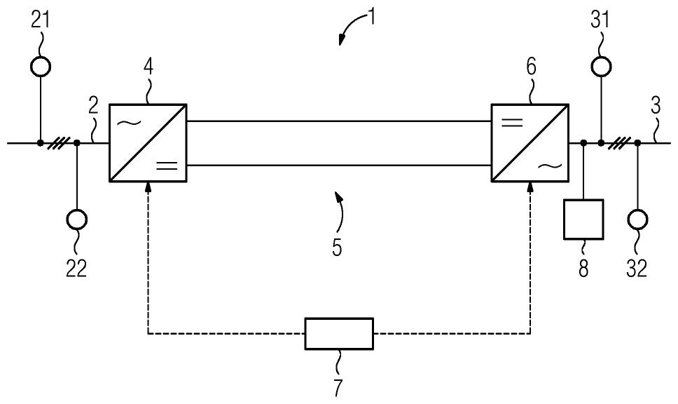

The invention relates to an arrangement for electrically connecting a first and a second supply system.

Electrical energy can be exchanged between the two supply systems by means of such an arrangement.

Small, autonomous supply systems (microgrids) should in future be able to cover their own energy requirement as far as possible through their own generation. Depending on the energy sources, the quantity of energy available is subject to variations both in terms of availability and of quality. Coupling to an external source/supplier is necessary in order to be able to obtain further energy in the event of a (temporary) under-supply.

This has the result that small systems are still heavily dependent on higher-level, high-voltage supply and its stabilization, and are thus bound to its specifications as well as its business models. This applies in particular when large industrial consumers or generators are located within these microgrids.

A complete independence from central (high-voltage) systems is at present scarcely possible for non-central supply systems, since both the reliability of the supply as well as the stabilizing components of the higher-level infrastructure (reactive power, for example) remain as necessary as ever, and can only be ensured in the non-central system itself in association with high expense.

Coupling to a higher-level high-voltage infrastructure would be possible, but this, however, conflicts with the non-central approach.

An HVDC coupling for the transmission of electrical energy between non-central systems is uneconomical, and unrealistic from the point of view of acceptance.

The object of the invention is to propose an arrangement of this general type that is as economical and reliable as possible.

The object is achieved within an arrangement of this general type in that the arrangement comprises the following components: a medium-voltage DC line, a first converter, which can be connected on the AC side to the first supply system and on the DC side to the medium-voltage DC line, a second converter, which can be connected on the AC side to the second supply system and on the DC side to the medium-voltage DC line, and a control device, which is configured to control the electrical power transmission in the medium-voltage DC line by means of at least one of the converters in such a way that a temporary excess of energy in the first supply system can be transmitted to the second supply system in order to stabilize it.

The approach to a solution here is that a non-central, local supply system is connected to another non-central, local supply system so that the necessary energy can be drawn from the neighboring system if the need arises. For neighboring supply systems that are sufficiently close to one another, this connection should be realized by means of a medium-voltage DC transmission (MVDC). In energy transmission technology in general, medium voltage is understood to refer to voltages below 60 kV.

This has the advantage that the necessary infrastructure for this type of coupling can be implemented in a more compact and economical form than is the case with a conventional high-voltage DC transmission or high/very high voltage AC transmission. It is also the fact that no high-voltage routes, or very few, are necessary for the lines.

It is furthermore possible through the AC/DC-DC/AC conversion to reduce variations in the frequency and voltage level for the transmission, and thus to minimize the effect of differences in quality; this can above all be relevant when a plurality of non-central supply systems are connected together over the MVDC connection or a medium-voltage system. It is furthermore also possible as a result for the unstable supply system to be stabilized by components and methods from the MVDC coupling. The stabilizing effect can, in particular, also be achieved when a medium-voltage DC system connects more than two supply systems together.

For cases in which a temporary excess is generated in one of the supply systems, this (excess) energy can be made available to the other participants over the MVDC link, and the energy can thus also be non-centrally traded between the supply systems concerned. The system operator (Distribution System Operator, DSO) that makes the MVDC infrastructure available can then charge its own system fee in proportion to the traded energy. Further system elements (electrical energy stores, thermal energy stores) can, moreover be connected in a controlled manner for the further stabilization of the microgrid or of the supply systems.

The technology available to date with which electrical energy can be transported over a large distance (HVDC) is not profitable for the transmission of smaller quantities of energy, and also not for a shorter distance.

The technology available to date with which electrical energy is distributed over a broad area (HVAC, 110 kV) is only inadequately suited to the controlled transmission of defined quantities of energy, since the energy flow cannot be regulated. Due to the predominant connection in the past of the generating plant in the form of large plant installations to the 110 kV system level, and the inability to further develop the system simultaneously, numerous system bottlenecks have nevertheless formed in the high-voltage systems; these are currently handled through the conditional reduction in the input power. This state can be countered through a specific curtailment of the quantity of energy in the overloaded local supply systems, and by specifically transporting the energy away over the medium-voltage DC transmission system.

Bearing these points of view in mind, the necessity of developing the system in the local system as well as on the distribution system level can be reconsidered.

In order to be able to connect smaller, local supply systems to one another for the exchange of energy and for stabilization of their own supply system, a more compact technology, including appropriate regulation, is necessary. Coupling at least two autonomous (small) supply systems over an MVDC connection permits a mutual supply and stabilization. The stabilization can for example here comprise a frequency stabilization, an attenuation of variations in the supply system and/or a voltage balancing in the supply system.

The configuration consists of a grouping of at least two local systems via an MVDC link.

The supply system or systems conveniently comprise one or more of the following participants or connected components:
consumers (homes, industry, the public sector, mobility),
generators (wind, PV, other renewable sources . . . ),
storage facilities,
internal control for power flow distribution,
connection to an MVDC system (converter station).

Instead of a local supply system, it is also possible for an individual large consumer to be connected to the MVDC system or to the MVDC line, said system being exclusively coupled via MVDC or requiring, for reasons of redundancy (data centers, critical infrastructure), a further source (to one/a plurality of other systems via MVDC) in addition to their original coupling (coming, for example, from the high-voltage side).

The connecting infrastructure preferably comprises:
MV lines,
a higher-level regulation that can make temporary excesses available to the MVDC group from a local system when correspondingly required.

There is thus a possibility for energy trading between the local systems. The function of the DSO can be created in the supply system itself.

Central storage facilities can be provided in order to hold excesses from the local systems in reserve and for generation of the DSO.

According to one form of embodiment of the invention, the arrangement comprises a central energy store in which a temporary excess of energy can be stored. The storage of the energy in the energy store can, for example, be carried out by means of the control device. Preferably the energy store is an electrical or thermal storage facility.

According to a further form of embodiment of the invention, the arrangement comprises a plurality of medium-voltage DC lines that are joined to form a medium-voltage DC system, wherein the arrangement connects three or more supply systems together by means of the medium-voltage DC system. In this arrangement, the supply systems that are connected to the medium-voltage DC system can particularly effectively ensure a mutual stabilization.

The converters can, for example, be realized as a voltage DC link converter (VSC) or the modular multi-stage converters (MMC) known to the expert. One possible storage concept is the “SieStorage” product from Siemens AG.

The invention further relates to a method for operating an electrical supply system.

The object of the invention is to provide such a method that enables the most effective possible operation of the supply system.

The object is achieved by a method of this general type in that a temporary excess of energy in the supply system is made available via a medium-voltage DC line, to which the supply system can be connected by means of a converter, to a further supply system connected to the medium-voltage DC line.

In this way the supply system can advantageously be operated particularly effectively, in particular in that the further supply system is stabilized in the manner described previously.

The figure shows an exemplary embodiment of an arrangement according to the invention.

The figure illustrates in detail an arrangement 1 for electrically connecting a first supply system 2 and a second supply system 3.

The first supply system 2 is a three-phase system, and comprises a plurality of consumers and energy generators 21 and 22 respectively. The second supply system 3 is also a three-phase system, and correspondingly comprises a plurality of consumers and energy generators 31 and 32 respectively.

The arrangement 1 further comprises a first converter 4 that is connected on the AC side to the first AC system 2 and on the DC side to a medium-voltage DC transmission line 5.

The arrangement 1 also comprises a second converter 6 that is connected on the AC side to the second AC system 3 and on the DC side to a medium-voltage DC transmission line 5.

A control device 7 is configured to control the electrical power transmission in the medium-voltage DC line 5 by means of at least one of the converters 2 or 3 in such a way that a temporary excess of energy in the first supply system 2 can be transmitted to the second supply system 3, or vice versa. This means that the second supply system 3 can be stabilized in terms of its system stability, such as system frequency, balancing and voltage variations. The system stabilization can, of course, also take place in the opposite direction, from the second supply system 3 to the first supply system 2.

1-6. (canceled)

7. An arrangement for connecting first and second electrical supply systems, the arrangement comprising:
a medium-voltage DC line;
a first converter to be connected on an AC side to said first supply system and on a DC side to said medium-voltage DC line;
a second converter to be connected on an AC side to said second supply system and on a DC side to said medium-voltage DC line; and
a control device configured to control an electrical power transmission in said medium-voltage DC line by using at least one of said converters for transmitting a temporary excess of energy in said first supply system to said second supply system for stabilizing said second supply system.

8. The arrangement according to claim 7, which further comprises a central storage facility for storing a temporary excess of energy.

9. The arrangement according to claim 8, wherein said energy storage facility is an electrical or thermal storage facility.

10. The arrangement according to claim 7, wherein said medium-voltage DC line is one of a plurality of medium-voltage DC lines being joined to form a medium-voltage DC system, and said medium-voltage DC system connects at least three supply systems together.

11. The arrangement according to claim 7, wherein at least one of said first or second converter is a voltage DC link converter.

12. A method for operating an electrical supply system, the method comprising the following steps:
providing a medium-voltage DC line, a converter for connecting the electrical supply system to the medium-voltage DC line, and a further supply system connected to the medium-voltage DC line; and
making a temporary excess of energy in the supply system available over the medium-voltage DC line to the further supply system to stabilize the further supply system.

13. The method according to claim 12, which further comprises using a further converter to connect the further supply system to the medium-voltage DC line.

14. The method according to claim 12, which further comprises using a control device to carry out the step of making the excess energy available to the further supply system.
